(19) United States
(12) Patent Application Publication
(10) Pub. No.: US 2026/0300175 A1
(43) Pub. Date: Oct. 1, 2026

(54) Merging Directory Updates for Reduced Latency

(71) Applicant: Advanced Micro Devices, Inc., Santa Clara, CA (US)

(72) Inventors: Ashish Sharma, Bangalore (IN); Patrick James Shyvers, Fort Collins, CO (US); Subramaniam Venkata Kalambur, Bangalore (IN); Paul James Moyer, Fort Collins, CO (US)

(73) Assignee: Advanced Micro Devices, Inc., Santa Clara, CA (US)

(21) Appl. No.: 19/096,478

(22) Filed: Mar. 31, 2025

(51) Int. Cl. G06F 12/0808

(52) U.S. Cl. CPC G06F 12/0808; G06F 2212/621

(57) ABSTRACT

In accordance with the described techniques, a device includes a plurality of processor cores, each associated with a cache system, and a cache controller configured to receive memory access requests to the cache system from the plurality of processor cores. The device also includes a directory communicatively coupled to the cache controller and configured to receive a self-invalidating lookup command from the cache controller caused by a request to update a cache line. The directory is further configured to perform a lookup operation to identify a processor core having a copy of the cache line, initiate one or more invalidation sequences for each processor core having a copy of cache line, and update cache line states to reflect invalidation of the cache line.

### BACKGROUND

Computer systems utilize various memory structures to store and access data efficiently. Cache systems provide fast access to frequently used data in modern processor architectures. These cache systems typically employ directories to track the status and location of cached data across one or more processor cores. As processor designs evolve to include more cores and handle increasingly complex workloads, managing cache coherency and minimizing latency in directory operations has become increasingly important to maintain system performance. Directory-based cache coherence protocols help ensure data consistency across multiple caches while facilitating efficient data sharing among processor cores.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system to implement techniques for merging directory updates for reduced latency.

FIG. 3 depicts a non-limiting example in which a cache controller performs a self-invalidating lookup in a directory to implement techniques for merging directory updates.

FIG. 4 depicts a procedure in an example implementation of merging directory updates for reduced latency.

### DETAILED DESCRIPTION

### Overview

A processor generally includes a cache controller, a cache system with multiple cache levels, and a directory for tracking cache line states across multiple processor cores. The cache system is organized in a hierarchy, typically including level one, level two, and last level caches. The cache controller utilizes the directory to track which cores have copies of particular cache lines to maintain cache coherency across multiple cores.

Conventional directory-based cache coherence protocols often utilize multiple separate operations to perform lookup and invalidation operations when updating shared cache lines. This conventional approach can lead to increased latency and congestion in the directory pipeline, especially in systems with multiple cores and widely shared data. For instance, a typical sequence might involve a directory lookup, followed by multiple individual invalidation requests and directory writes for each core holding a copy of the cache line.

To address these limitations, the described techniques introduce a primitive operation referred to herein as a self-invalidating lookup. When the cache controller receives a request to update a cache line or for exclusive access, the cache controller issues the self-invalidating lookup command to the directory. In response, the directory performs a lookup operation to identify which processor cores have copies of the target cache line. The directory then initiates invalidation sequences for the identified records without requiring additional commands from the cache controller.

The described approach offers several advantages over conventional techniques. Combining the lookup and invalidation operations, the described techniques reduce the number of separate commands traversing the directory pipeline. The self-invalidating lookup operation alleviates congestion and decreases overall latency, particularly for workloads involving frequent updates to widely shared data. Additionally, the self-invalidating lookup allows the directory to update cache line states for multiple cores in a single operation, eliminating separate write commands for each affected core.

The described techniques also provide flexibility in implementation. The self-invalidating lookup is configurable to perform the lookup and initiate invalidations in a single pipeline cycle for maximum efficiency. A pipeline cycle is a single stage or step in a sequence of operations performed by the processor and other components in a computer system. In another implementation, the self-invalidating lookup is configurable to split these operations across two or more cycles. Furthermore, the directory can be logically banked to allow concurrent access, further improving throughput.

By streamlining directory operations and reducing communication overhead between the cache controller and directory, the described techniques enable more efficient handling of cache coherence in multi-core systems. This results in reduced latency for memory operations, improved scalability as core counts increase, and enhanced overall system performance compared to conventional approaches.

In some aspects, the techniques described herein relate to a device comprising a plurality of processor cores, each processor core being associated with a cache system, a cache controller configured to receive memory access requests to the cache system from the plurality of processor cores, and a directory communicatively coupled to the cache controller and configured to receive a self-invalidating lookup command from the cache controller caused by a request to update a cache line, perform a lookup operation in the directory to identify each processor core having a copy of the cache line in response to the self-invalidating lookup command, initiate one or more invalidation sequences for each processor core having a copy of the cache line, and update cache line states to reflect invalidation of the cache line.

In some aspects, the techniques described herein relate to a device wherein the directory comprises a plurality of directories, each directory configured to track the cache line states across a corresponding processor core.

In some aspects, the techniques described herein relate to a device wherein the directory is further configured to perform the lookup operation and initiate the one or more invalidation sequences in parallel in a single pipeline cycle.

In some aspects, the techniques described herein relate to a device wherein the directory is configured to perform the lookup operation in a first pipeline cycle and initiate the one or more invalidation sequences in a second pipeline cycle.

In some aspects, the techniques described herein relate to a device wherein the directory is configured to initiate the one or more invalidation sequences without further communication from the cache controller.

In some aspects, the techniques described herein relate to a device wherein the directory is configured to initiate the one or more invalidation sequences just for each processor core identified as having a copy of the cache line.

In some aspects, the techniques described herein relate to a device wherein the self-invalidating lookup command includes an index and a tag for identifying the cache line.

In some aspects, the techniques described herein relate to a device wherein the directory is configured to update the cache line states without receiving separate write commands from the cache controller for each processor core of the plurality of processor cores.

In some aspects, the techniques described herein relate to a device wherein the directory comprises a plurality of logically banked directories to allow concurrent access to different banked directories.

In some aspects, the techniques described herein relate to a device wherein the cache controller is configured to issue the self-invalidating lookup command caused by a request for exclusive access to the cache line.

In some aspects, the techniques described herein relate to a device wherein the directory is configured to provide a response to the cache controller indicating results of the lookup operation.

In some aspects, the techniques described herein relate to a processor comprising a cache system having one or more cache levels, a directory to track cache line states in the cache system for one or more processor cores, and a cache controller communicatively coupled to the directory and configured to receive, from a processor core of the one or more processor cores, a memory access request to a cache line in the cache system, send a self-invalidating lookup command to the directory, the self-invalidating lookup command configured to cause the directory to perform a lookup operation to identify each processor core having a copy of the cache line and initiate one or more invalidation sequences for the processor core, and receive, from the directory, a response indicating results of the self-invalidating lookup command.

In some aspects, the techniques described herein relate to a processor wherein the directory comprises a plurality of directories, each directory configured to track the cache line states across a corresponding processor core.

In some aspects, the techniques described herein relate to a processor wherein the self-invalidating lookup command further causes the directory to perform the lookup operation and initiate the one or more invalidation sequences in parallel in a single pipeline cycle.

In some aspects, the techniques described herein relate to a processor wherein the directory is configured to initiate the one or more invalidation sequences without further communication from the cache controller.

In some aspects, the techniques described herein relate to a processor wherein the self-invalidating lookup command causes the directory to update the cache line states without receiving separate write commands from the cache controller for each processor core of the one or more processor cores.

In some aspects, the techniques described herein relate to a processor wherein the self-invalidating lookup command includes an index and a tag for identifying the cache line.

In some aspects, the techniques described herein relate to a processor wherein the cache controller is further configured to issue the self-invalidating lookup command caused by a request for exclusive access to the cache line.

In some aspects, the techniques described herein relate to a processor wherein the self-invalidating lookup command causes the directory to initiate the one or more invalidation sequences just for the processor core identified as having a copy of the cache line.

In some aspects, the techniques described herein relate to a method comprising receiving, by a directory from a cache controller communicatively coupled to the directory, a self-invalidating lookup command caused by a request to update a cache line, performing a lookup operation to identify each processor core having a copy of the cache line, initiating an invalidation sequence for each processor core having the copy of the cache line, and updating cache line states in the directory to reflect invalidation of the cache line.

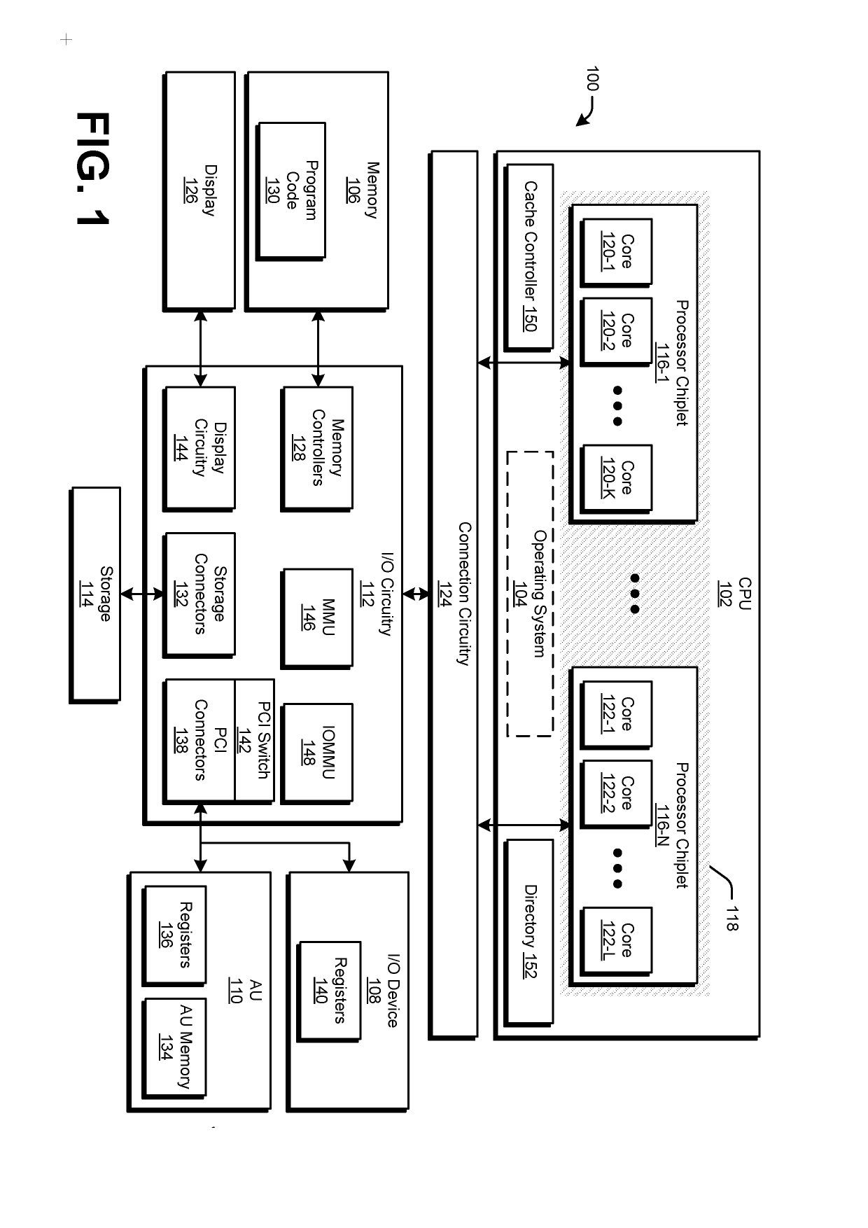

FIG. 1 is a block diagram of a processing system 100 configured to execute one or more applications, in accordance with one or more implementations. In particular, processing system 100 is configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as "threads," for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example implementation presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both. In other implementations, the CPU 102 is a monolithic system.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

The CPU 102 includes a cache controller 150 that manages data flow between the processor cores 120, 122 and a cache system. The cache controller 150 is configured to receive memory access requests from the processor cores 120, 122 and coordinate with directory 152 to fulfill these requests. The directory 152 tracks the status of cached data across the multiple processor cores 120, 122. The directory 152 maintains information about which cache levels store copies of particular cache lines, enabling efficient cache coherence management across the processor chiplets 116.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. These memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 128 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

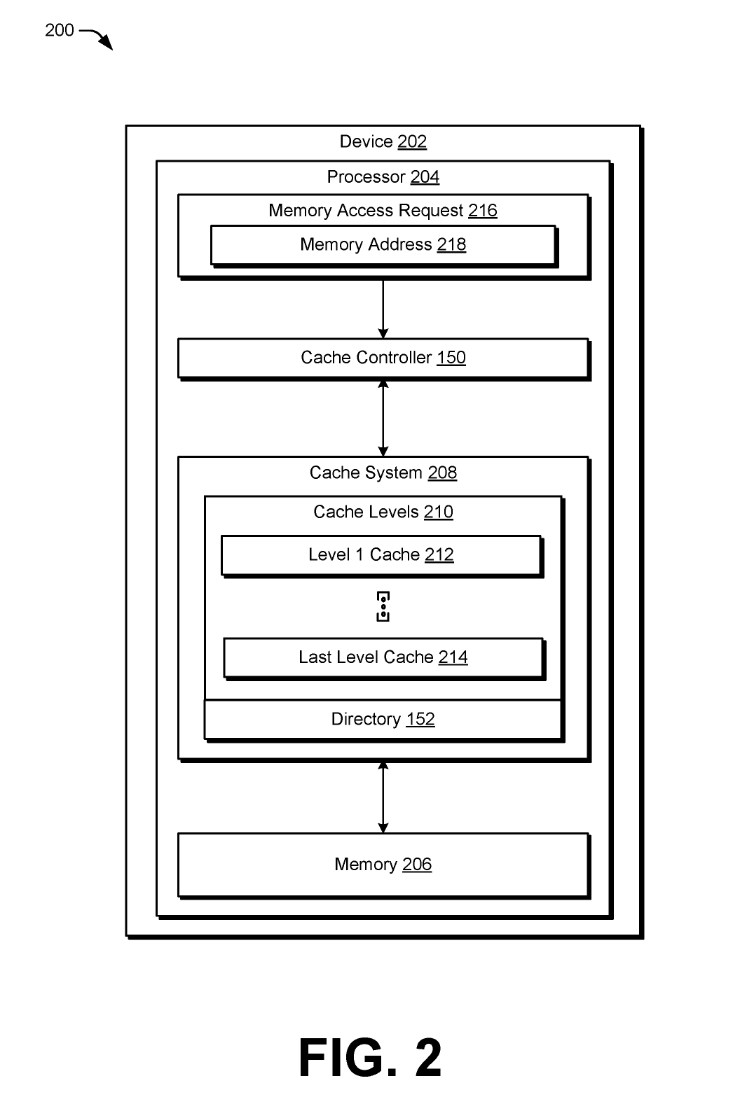

FIG. 2 is a block diagram of a non-limiting example system 200 to implement techniques for merging directory updates for reduced latency. The system 200 includes a device 202 having a processor 204 and a memory 206. The device 202 is configured to implement the processing system 100 described in relation to FIG. 1.

The processor 204 includes a cache system 208 comprising multiple cache levels 210. In this example, the cache system 208 includes a level one cache 212 and a last level cache 214. The cache system 208 is organized hierarchically, with higher level caches like the level one cache 212 providing faster access times but smaller storage capacity than lower level caches like the last level cache 214. The last level cache 214 is typically shared among multiple processor cores within the processor 204.

The level one cache 212 is typically the smallest and fastest cache, located closest to the processor cores. The level one cache 212 is often split into separate instruction and data caches to allow simultaneous access to instructions and data. The last level cache 214 is larger and slower than the level one cache 212, but still significantly faster than accessing the memory 206. The last level cache 214 is typically shared among multiple processor cores within the processor 204. The last level cache 214 can be a distributed or monolithic cache.

The memory 206 of the device 202 serves as the main memory for the system 200. The cache system 208 operates as an intermediary between the processor 204 and the memory 206, storing frequently accessed data to reduce memory access latency. When a requested piece of data is not found in the cache system 208, it is retrieved from memory 206 and potentially stored in one or more levels of the cache system 208 for future access.

The device 202 comprises a plurality of processor cores, each associated with the cache system 208. This multi-core architecture allows for parallel processing of tasks, with each core potentially working on different threads or processes simultaneously. The cache system 208, particularly the shared last level cache 214, helps maintain coherency across these multiple cores by ensuring that each core has access to the most up-to-date data.

The processor 204 also includes the cache controller 150 and the directory 152 described previously in relation to FIG. 1. The cache controller 152 is a hardware component that manages data flow between processor cores and the cache system 208. The cache controller coordinates cache operations, handles memory access requests, and interacts with the directory 152 to maintain cache coherence across multiple processor cores. The cache controller 150 is configured to receive memory access requests 216 from the plurality of processor cores within the processor 204. Each memory access request 216 includes a memory address 218 indicating the data line being accessed. The cache controller 150 uses the memory address 218 to determine if the requested data is present in the cache system 208 or if it is to be retrieved from memory 206.

When the cache controller 150 receives a memory access request 216, the cache controller 150 first checks the level one cache 212 for the requested data. If the data is not found in the level one cache 212, the cache controller 150 checks the subsequent cache levels, including the last level cache 214. If the data is not found in any of the cache levels 210, the cache controller 150 initiates a memory access to retrieve the data from the memory 206.

The directory 152 is communicatively coupled to the cache controller 150. The directory 152 includes hardware components and/or data structures that track the status and location of cached data across the multiple processor cores, maintaining information about which cache levels store copies of particular data lines. The directory 150 stores metadata such as cache line states, ownership information, and sharing status to facilitate efficient cache coherence management and reduce unnecessary coherence traffic. The information in the directory 152 indicates whether a cache line is valid, modified, or shared across multiple cores.

In one or more implementations, the directory 152 includes a plurality of directories, each configured to track the cache line states across a corresponding processor core. This organization of the directory 152 allows for parallel lookups and updates across multiple cores, improving the efficiency of cache coherence operations.

In one or more implementations, the directory 152 is part of the shared last level cache 214 hierarchy. Alternatively, the directory 152 is located at a memory controller, such as one of the memory controllers 128 described in relation to FIG. 1. To further enhance performance, the directory 152 includes a plurality of logically banked directories to allow concurrent access to different banked directories in one implementation. This banked organization enables simultaneous multiple lookup and update operations, reducing contention and improving throughput in the directory pipeline.

The cache controller 150 and directory 152 work together to implement the directory update merging technique. When the cache controller 150 receives a memory access request 216 that requires updating a cache line, the cache controller 150 uses the directory 152 to determine which cores have copies of the cache line and what actions to perform to maintain coherence. In particular, the cache controller 150 issues a self-invalidating lookup command to the directory 152. This self-invalidating lookup command combines the lookup and invalidation operations into a single operation, reducing congestion in the directory pipeline.

Upon receiving the self-invalidating lookup command, the directory 152 performs a lookup operation to identify which processor cores have copies of the target cache line. The directory 152 then initiates invalidation sequences for the identified cores without requiring additional commands from the cache controller 150. This approach allows the directory 152 to update cache line states for multiple cores in a single operation, eliminating the need for separate write commands for each affected core.

The self-invalidating lookup command is used upfront in place of a regular lookup command. When the cache controller 150 receives a request for exclusive access, instead of issuing a standard lookup followed by separate invalidation commands, the cache controller 150 issues the self-invalidating lookup command to the directory 152. This approach streamlines the process of obtaining exclusive access to a cache line.

The self-invalidating lookup command also merges multiple directory write commands into a single update. In scenarios where multiple cache lines are to be invalidated across various processor cores, the cache controller 150 issues a single self-invalidating lookup command instead of multiple separate write commands. This consolidation reduces the number of operations that traverse the directory pipeline.

Implementing the directory update merging technique, system 200 reduces latency and congestion in the directory pipeline, particularly for workloads involving frequent updates to widely shared data. This results in improved overall system performance, especially as the number of processor cores increases and data sharing becomes more prevalent. In particular, by maintaining detailed information about cache line states and providing mechanisms for fast lookups and updates, the described techniques reduce latency for memory operations and improve overall system performance, particularly in scenarios involving frequent updates to widely shared data.

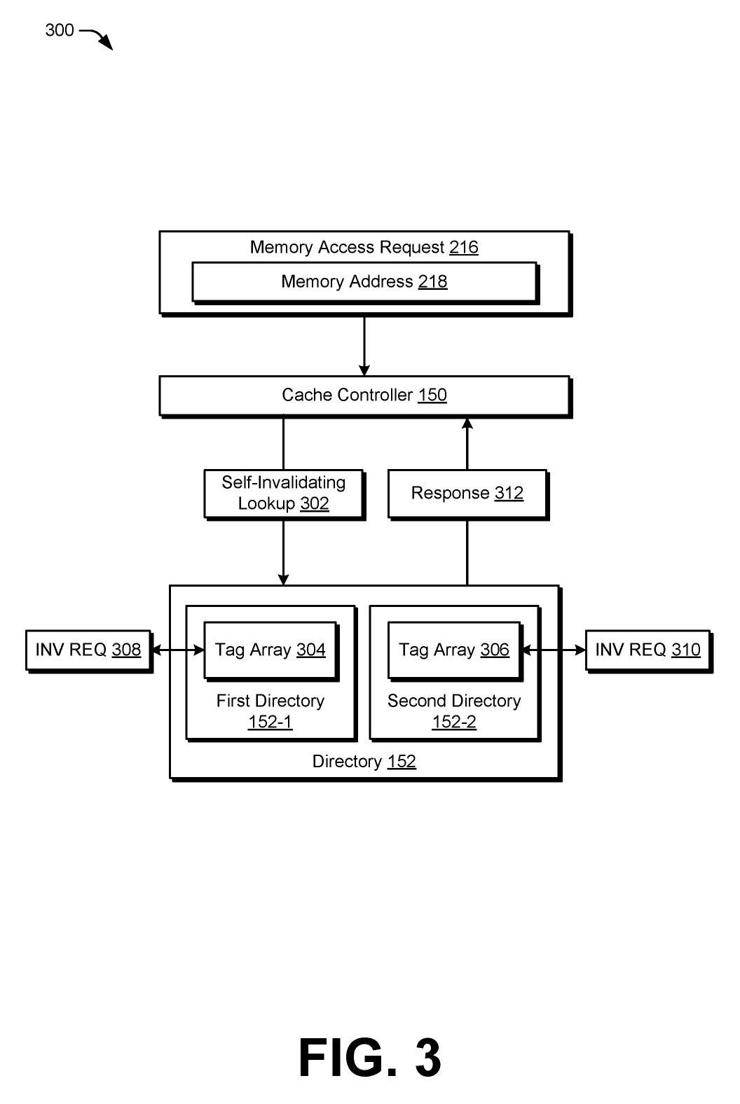

FIG. 3 depicts a non-limiting example 300 in which a cache controller performs a self-invalidating lookup 302 in the directory to implement techniques for merging directory updates. The self-invalidating lookup 302 enables efficient handling of memory access requests 216 that require updating a cache line across multiple processor cores.

The cache controller 150 receives a memory access request 216, including a memory address 218. In response to the memory access request 216 triggering an update to a cache line, the cache controller 150 issues a self-invalidating lookup 302 to the directory 152. The self-invalidating lookup 302 is a combined operation that performs both a directory lookup and initiates invalidation sequences for identified cache lines in a single command. This operation allows the directory 152 to autonomously handle the lookup and invalidation processes without requiring additional commands from the cache controller 150, reducing latency and improving efficiency in cache coherence management. The self-invalidating lookup 302 includes an index and a tag for identifying the cache line based on the memory address 218.

Upon receiving the self-invalidating lookup 302, the directory 152 performs a lookup operation to identify each processor core having a copy of the cache line. The directory 152 includes a first directory 152-1 and a second directory 152-2, each associated with different processor cores or cache levels. The directory 152 supports various coherence protocols, such as MESI (Modified, Exclusive, Shared, Invalid) or MOESI (Modified, Owned, Exclusive, Shared, Invalid).

The first directory 152-1 contains a first tag array 304, while the second directory 152-2 contains a second tag array 306. The tag arrays store address tags that identify cached memory locations for their respective cores or cache levels. The tag arrays 304 and 306 enable efficient lookup operations to determine which processor cores have copies of specific cache lines. The tag arrays 304 and 306 also store the appropriate state information for each cache line, allowing the directory 152 to enforce the chosen coherence protocol efficiently.

The directory 152 also supports scalability as the number of processor cores increases. The modular design with separate directories and tag arrays allows for easy expansion to accommodate additional cores or cache levels. This scalability ensures that the cache coherence mechanism remains efficient even in systems with a large number of processor cores.

The directory 152 simultaneously interacts with the first directory 152-1 and the second directory 152-2 to process the self-invalidating lookup 302. The directory 152 uses the index and tag provided in the command to search the tag arrays 304 and 306 for matching entries. When a match in either tag array indicates that a corresponding processor core has a copy of the cache line, the directory internally initiates an invalidation sequence for that copy of the cache line. The invalidation sequence refers to a process of marking the cache line states as invalid across one or more processor cores or cache levels within the directory 152. In one implementation, the invalidation sequence involves sending messages or signals, by the cache controller 150, to the relevant cores or cache levels to update their cache line, ensuring data consistency across the system.

For the first directory 152-1, if a matching entry is found in the first tag array 304, an invalidation request 308 is generated. This invalidation request 308 triggers an invalidation process for the associated processor core.

Similarly, for the second directory 152-2, if a matching entry is found in the second tag array 306, an invalidation request 310 is generated. This leads to an invalidation process for the corresponding processor core or cache level. The directories 152 are configured to update cache line states to reflect the invalidation of the cache line. This update occurs autonomously and automatically within the directories 152, without requiring additional commands from the cache controller 150. The directory 152 provides a response 312 to the cache controller 150 in the same cycle as the internal self-invalidation by the directory 152. The response 312 allows the cache controller 150 to track the progress of the invalidation operations.

The self-invalidating lookup 302 operation allows the directory 152 to perform both the lookup and invalidation steps without requiring additional commands from the cache controller 150. The invalidation sequences are initiated specifically for the processor cores with copies of the target cache line. The directory 152 does not issue invalidation requests for cores that do not have copies of the cache line, focusing the invalidation process on necessary targets and reducing unnecessary invalidation traffic.

The self-invalidating lookup operation streamlines obtaining exclusive access to a cache line. When a processor core modifies data in a shared cache line, the cache controller 150 issues the self-invalidating lookup 302 instead of separate lookup and invalidation commands. This consolidation reduces the communication overhead between the cache controller 150 and the directory 152, improving overall system performance. The directory 152 also schedules the internal invalidation in the same cycle as the lookup result. This concurrent scheduling allows for rapid initiation of the invalidation process, minimizing latency between the lookup and invalidation steps.

In one implementation, the cache controller 150 optionally drops the response generated by the directory 152 for the self-invalidating lookup 302. This option allows the cache controller 150 to optimize operations based on specific requirements of the memory access request. When cache controller 150 does not process the lookup results directly, dropping the response reduces unnecessary data transfer and processing overhead.

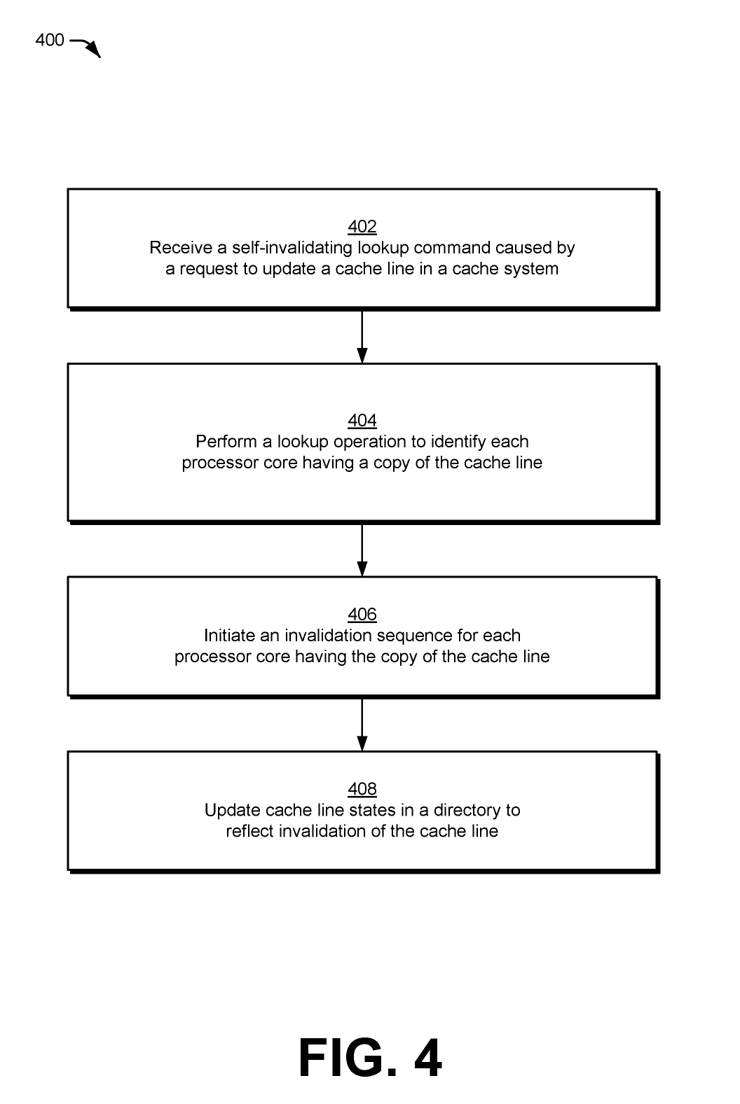

FIG. 4 depicts a procedure 400 in an example implementation of merging directory updates for reduced latency. The procedure 400 begins at block 402, where a self-invalidating lookup command is received, which was caused by a request to update a cache line in a cache system. For example, the self-invalidating lookup command is issued by the cache controller, which manages data flow between the processor cores and the cache system.

Proceeding to block 404, a lookup operation is performed by a directory to identify each processor core having a copy of the cache line. In this way, the directory determines which processor cores are affected by the requested update and have cache lines to be invalidated to maintain data coherence across the system. The directory is communicatively coupled to the cache controller. In one implementation, the directory includes multiple directories, each configured to track cache line states across corresponding processor cores.

At block 406, an invalidation sequence is initiated for each processor core identified as having a copy of the cache line. This invalidation sequence ensures that each copy of the cache line in different processor cores are invalidated, thereby preventing data inconsistency and potential errors in data processing. The directory autonomously and automatically initiates this invalidation sequence without further commands from the cache controller.

Finally, at block 408, cache line states are updated in the directory to reflect the invalidation of the cache line. The directory ensures that changes to cache line states are accurately recorded and maintained.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 202, the processor 204, the memory 206, the cache system 208, the cache controller 150, and the directory 152) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or processor. Examples of non-transitory computer-readable storage mediums include read-only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A device comprising:
a plurality of processor cores, each processor core being associated with a cache system;
a cache controller configured to receive memory access requests to the cache system from the plurality of processor cores; and
a directory communicatively coupled to the cache controller and configured to:
receive a self-invalidating lookup command from the cache controller caused by a request to update a cache line;
perform a lookup operation in the directory to identify each processor core having a copy of the cache line in response to the self-invalidating lookup command;
initiate one or more invalidation sequences for each processor core having a copy of the cache line; and
update cache line states to reflect invalidation of the cache line.

2. The device of claim 1, wherein the directory comprises a plurality of directories, each directory configured to track the cache line states across a corresponding processor core.

3. The device of claim 1, wherein the directory is further configured to perform the lookup operation and initiate the one or more invalidation sequences in parallel in a single pipeline cycle.

4. The device of claim 1, wherein the directory is configured to perform the lookup operation in a first pipeline cycle and initiate the one or more invalidation sequences in a second pipeline cycle.

5. The device of claim 1, wherein the directory is configured to initiate the one or more invalidation sequences without further communication from the cache controller.

6. The device of claim 1, wherein the directory is configured to initiate the one or more invalidation sequences just for each processor core identified as having a copy of the cache line.

7. The device of claim 1, wherein the self-invalidating lookup command includes an index and a tag for identifying the cache line.

8. The device of claim 1, wherein the directory is configured to update the cache line states without receiving separate write commands from the cache controller for each processor core of the plurality of processor cores.

9. The device of claim 1, wherein the directory comprises a plurality of logically banked directories to allow concurrent access to different banked directories.

10. The device of claim 1, wherein the cache controller is configured to issue the self-invalidating lookup command caused by a request for exclusive access to the cache line.

11. The device of claim 1, wherein the directory is configured to provide a response to the cache controller indicating results of the lookup operation.

12. A processor comprising:
a cache system having one or more cache levels;
a directory to track cache line states in the cache system for one or more processor cores; and
a cache controller communicatively coupled to the directory and configured to:
receive, from a processor core of the one or more processor cores, a memory access request to a cache line in the cache system;
send a self-invalidating lookup command to the directory, the self-invalidating lookup command causing the directory to perform a lookup operation to identify each processor core having a copy of the cache line and initiate one or more invalidation sequences for the processor core; and
receive, from the directory, a response indicating results of the self-invalidating lookup command.

13. The processor of claim 12, wherein the directory comprises a plurality of directories, each directory configured to track the cache line states across a corresponding processor core.

14. The processor of claim 12, wherein the self-invalidating lookup command further causes the directory to perform the lookup operation and initiate the one or more invalidation sequences in parallel in a single pipeline cycle.

15. The processor of claim 12, wherein the directory is configured to initiate the one or more invalidation sequences without further communication from the cache controller.

16. The processor of claim 12, wherein the self-invalidating lookup command causes the directory to update the cache line states without receiving separate write commands from the cache controller for each processor core of the one or more processor cores.

17. The processor of claim 12, wherein the self-invalidating lookup command includes an index and a tag for identifying the cache line.

18. The processor of claim 12, wherein the cache controller is further configured to issue the self-invalidating lookup command caused by a request for exclusive access to the cache line.

19. The processor of claim 12, wherein the self-invalidating lookup command causes the directory to initiate the one or more invalidation sequences just for the processor core identified as having a copy of the cache line.

20. A method comprising:
receiving, by a directory from a cache controller communicatively coupled to the directory, a self-invalidating lookup command caused by a request to update a cache line;
performing a lookup operation to identify each processor core having a copy of the cache line;
initiating an invalidation sequence for each processor core having the copy of the cache line; and
updating cache line states in the directory to reflect invalidation of the cache line.
